(19) United States
(12) Patent Application Publication
(10) Pub. No.: US 2021/0365567 A1
(43) Pub. Date: Nov. 25, 2021

(54) DEVICE AND METHOD FOR REPAIRING SECURITY VULNERABILITY OF COMPUTER APPLICATION SOFTWARE

(71) Applicant: Haoyu CHEN, Wenzhou (CN)

(72) Inventor: Haoyu CHEN, Wenzhou (CN)

(21) Appl. No.: 17/393,422

(22) Filed: Aug. 4, 2021

(51) Int. Cl. G06F 21/57; G06F 21/56; G06F 21/55; G06F 8/41

(52) U.S. Cl. CPC G06F 21/577; G06F 21/568; G06F 2221/033; G06F 8/41; G06F 21/554

(57) ABSTRACT

Disclosed is a device for repairing a security vulnerability of computer application software, including vulnerability repairing software, computer application software and computer system software, where the vulnerability repairing software includes a main control module, a software vulnerability repairing module, a system virus repairing module, a system virus scanning module, a software vulnerability definition central database and a system virus definition central database; the main control module sends a notification to the software vulnerability scanning module and the system virus scanning module, respectively; the software vulnerability scanning module scans the computer application software for a security vulnerability, and the software vulnerability repairing module sends a repair command according to a comparison result; and the system virus scanning module scans the computer system software for a system virus, and the system virus repairing module sends a virus-killing command according to a comparison result.

### TECHNICAL FIELD

The present disclosure relates to the technical field of computers, and in particular, to a device and a method for repairing a security vulnerability of computer application software.

### BACKGROUND

A vulnerability is a defect in the implementation of hardware, software, protocols or system security policies, which can enable an attacker to access or destroy a system without authorization. A software security vulnerability is usually caused by the negligence of a developer during developing software, or by limitations of programming languages. At present, the threat of the computer software security vulnerability is becoming more and more serious. Hacking and virus destruction caused by the software security vulnerability are more likely to cause great harm. However, at present, the repair for network vulnerability is not reliable, stable and easy to use, and is easy to be restricted by various conditions, mainly including the following: it is unable to ensure the unified repair and treatment of computer software security vulnerabilities and computer system viruses; vulnerability repair programs and virus killing programs occupy a large amount of external bandwidth resources of the network, making it difficult to guarantee that the normal use of the network will not be affected.

### SUMMARY

In view of the problems existing in the prior art, the present disclosure aims at providing a device and a method for repairing a security vulnerabilities of computer application software.

In order to realize the above purpose, the present disclosure adopts the following technical scheme:

A device for repairing a security vulnerability of computer application software, including: vulnerability repairing software, computer application software and computer system software, where the vulnerability repairing software includes a main control module, a software vulnerability repairing module, a software vulnerability scanning module, a system virus repairing module, a system virus scanning module, a software vulnerability definition central database and a system virus definition central database; the main control module, the software vulnerability repairing module, the software vulnerability scanning module, the system virus repairing module, the system virus scanning module, the software vulnerability definition central database and the system virus definition central database interact information with the computer application software and the computer system software; the main control module sends a notification to the software vulnerability scanning module and the system virus scanning module, respectively; the software vulnerability scanning module scans the computer application software for a security vulnerability and sends a scanning result to the software vulnerability definition central database for comparison, and the software vulnerability repairing module sends, according to the comparison, a repair command to repair the computer application software; and the system virus scanning module scans the computer system software for a virus and sends a scanning result to the system virus definition central database for comparison, and the system virus repairing module sends a virus-killing command according to the comparison.

Preferably, the software vulnerability repairing module includes a repair code, and when the software security vulnerability is a Java layer vulnerability, the repair code includes a bytecode compiled by a program written in Java language for repairing the security vulnerability and running in a Java virtual machine, or a machine instruction compiled by a bytecode; and when the software security vulnerability is a Native layer vulnerability, the repair code includes a machine instruction compiled by a program written in C/C++ language for repairing the security vulnerability.

Preferably, the main control module compiles the computer application software and the computer system software into a language code text, and acquires, according to the language code text, a data structure of the computer application software and the computer system software; and the software vulnerability scanning module and the system virus scanning module scan the data structure.

Preferably, the software vulnerability repairing module repairs the security vulnerability of the computer application software, and the software vulnerability repairing module includes a repair program central download module, a repair program central cache module and a proxy module; the proxy module sends a download command to the repair program central download module, and the repair program central download module is configured to determine whether there is a repair program for the vulnerability in the repair program central cache module; when there is a repair program for the vulnerability, the repair program is read out and sent to the proxy module; and when there is no repair program, a repair program is acquired from the software vulnerability definition central database and sent to the proxy module, to find out and repair the security vulnerability of the computer application software.

Preferably, the system virus repairing module repairs a computer system software exception caused by a virus, and performs a system repair for the computer system software; when there is a system repair result indicating that there is a virus at a current stage, the system virus repairing module estimates a repair time for repairing the virus; if the repair time is greater than a maximum allowable repair time at the current stage, the system virus repairing module performs a virus killing operation on some of the viruses; and if the repair time is not greater than the maximum allowable repair time, the system virus repairing module performs a virus killing operation on all the viruses, where the virus killing operation includes forced deletion and thorough crushing of files.

Further, a method for repairing a security vulnerability of computer application software using the device for repairing the security vulnerability of the computer application software, including two implementation modes: I. the main control module of the vulnerability repairing software automatically scans the computer application software for a security vulnerability and the computer system software for a system virus regularly, and sends, according to a scanning result, a command to the software vulnerability repairing module and the system virus repairing module to repair the security vulnerability of the computer application software and the system virus of the computer system software; II. a user automatically controls the vulnerability repairing software to scan the computer application software for a security vulnerability and the computer system software for a system virus, and sends, according to a scanning result, a command to the software vulnerability repairing module and the system virus repairing module to repair the security vulnerability of the computer application software and the system virus of the computer system software.

Preferably, the mode I includes following steps: a. the main control module of the vulnerability repairing software automatically sends a scanning notification to the software vulnerability scanning module and the system virus scanning module, the software vulnerability scanning module scans the computer application software for a security vulnerability, and the system virus scanning module scans the computer system software for a system virus, and then the software vulnerability scanning module and the system virus scanning module send a scanning result back to the main control module, respectively; b. the main control module sends the scanning result to the software vulnerability definition central database and the system virus definition central database respectively for comparison and processes the scanning result; c. when there is a security vulnerability, the main control module sends a vulnerability repair command to the software vulnerability repairing module to repair the security vulnerability of the computer application software; and when there is a system virus, the main control module sends a virus killing command to the system virus repairing module to deal with the system virus of the computer system software.

Preferably, the mode II includes following steps: a. the user controls the main control module of the vulnerability repairing software to send a scanning notification to the software vulnerability scanning module and the system virus scanning module; the software vulnerability scanning module and the system virus scanning module respectively scan the computer application software for a security vulnerability and the computer system software for a the system virus, and send a scanning result back to the main control module; b. the main control module sends the scanning result to the software vulnerability definition central database and the system virus definition central database respectively for comparison and processes the scanning result; c. when there is a security vulnerability, the main control module sends a vulnerability repair command to the software vulnerability repairing module to repair the security vulnerability of the computer application software; and when there is a system virus, the main control module sends a virus killing command to the system virus repairing module to deal with the system virus of the computer system software.

Compared with the prior art, the present disclosure has the following prominent technical effects: the device for repairing the security vulnerability of the computer application software can repair the security vulnerability of the computer application software through the design of the software vulnerability scanning module and the software vulnerability repairing module, and can check and kill the system virus of the computer system software through the design of the system virus scanning module and the system virus repairing module, thereby completing the unified repair and treatment of the computer software security vulnerability and the system virus of the computer system. In addition, the repair code of the software vulnerability repairing module can compile the corresponding machine instructions according to the types of vulnerabilities, and the system virus repairing module can select different repair modes according to the repair time of viruses, thus reducing the external bandwidth resources of the network and ensuring the normal use of the network.

### BRIEF DESCRIPTION OF THE DRAWINGS

FIG. 1 is a system architecture diagram of a device for repairing a security vulnerability of computer application software;

FIG. 2 is a schematic diagram of vulnerability repair of the device for repairing the security vulnerability of the computer application software;

FIG. 3 is a schematic diagram of virus killing of the device for repairing the security vulnerability of the computer application software;

FIG. 4 is a flowchart of automatically sending a scanning notification by a main control module; and

FIG. 5 is a flowchart of controlling the main control module by a user to send a scanning notification.

### DETAILED DESCRIPTION

The technical schemes in the embodiments of the present disclosure will be clearly and completely described as below with reference to the accompanying drawings in the embodiments of the present disclosure. Obviously, the described embodiments are only a part of, not all of, the embodiments of the present disclosure. All other embodiments obtained by a person of ordinary skill in the art based on the embodiments of the present disclosure without creative effort shall fall into the protection scope of the present disclosure.

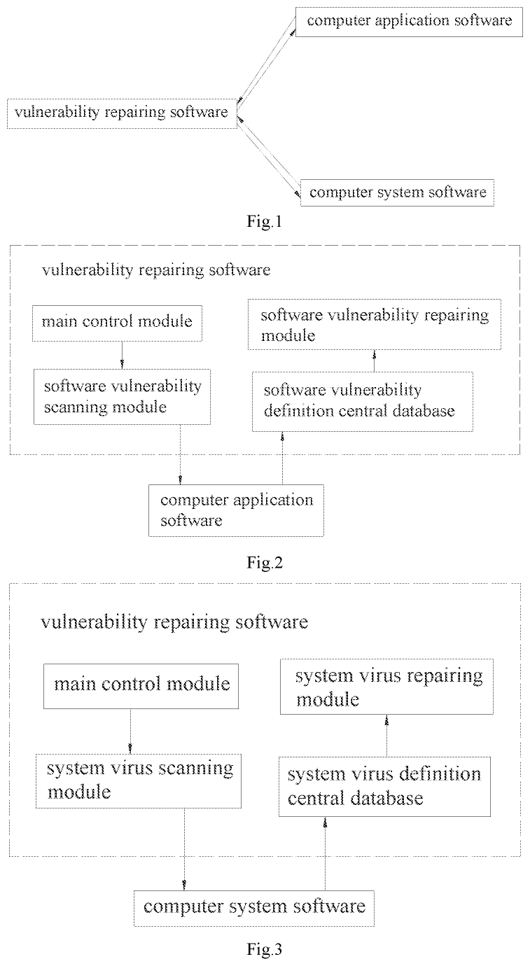

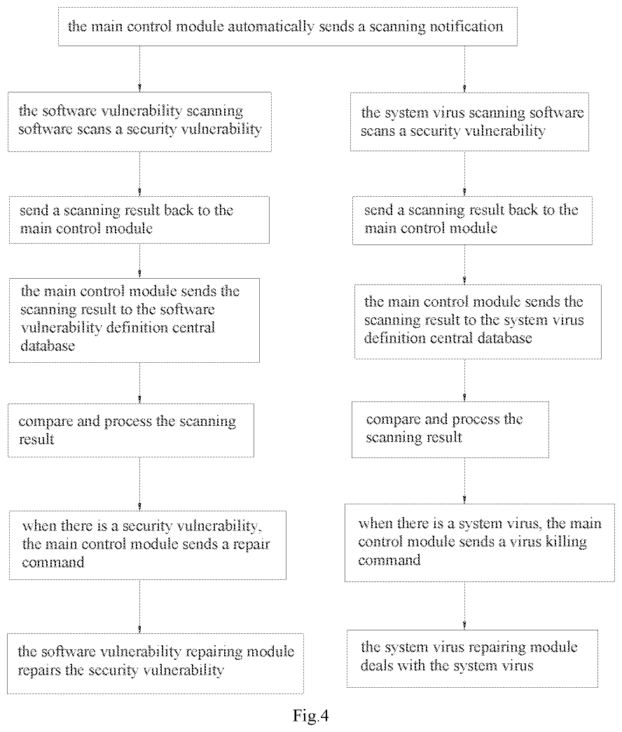

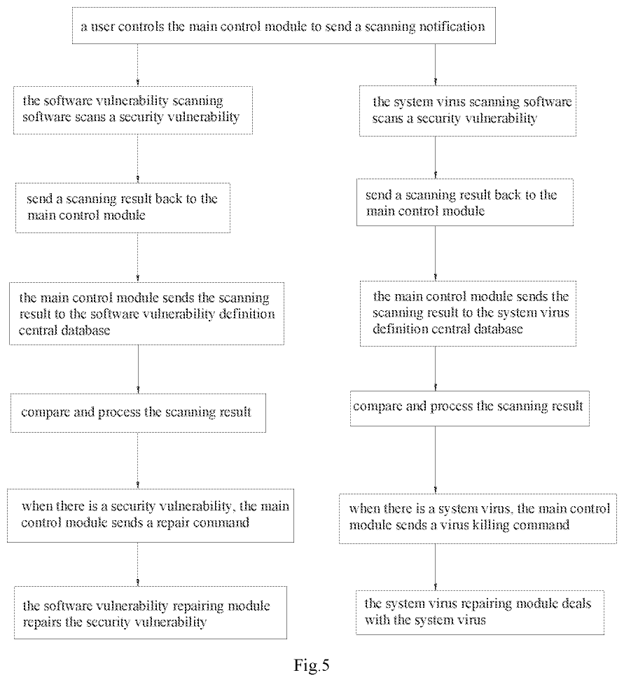

With reference to FIGS. 1-5, the present disclosure provides a technical scheme: a device for repairing a security vulnerability of computer application software, including: vulnerability repairing software, computer application software and computer system software, where the vulnerability repairing software includes a main control module, a software vulnerability repairing module, a software vulnerability scanning module, a system virus repairing module, a system virus scanning module, a software vulnerability definition central database and a system virus definition central database; the main control module, the software vulnerability repairing module, the software vulnerability scanning module, the system virus repairing module, the system virus scanning module, the software vulnerability definition central database and the system virus definition central database interact information with the computer application software and the computer system software; the main control module sends a notification to the software vulnerability scanning module and the system virus scanning module, respectively; the software vulnerability scanning module scans the computer application software for a security vulnerability and sends a scanning result to the software vulnerability definition central database for comparison, and the software vulnerability repairing module sends, according to the comparison, a repair command to repair the computer application software; and the system virus scanning module scans the computer system software for a system virus and sends a scanning result to the system virus definition central database for comparison, and the system virus repairing module sends a virus-killing command according to the comparison.

In some embodiments, the software vulnerability repairing module includes a repair code, and when the software security vulnerability is a Java layer vulnerability, the repair code includes a bytecode compiled by a program written in Java language for repairing the security vulnerability and running in a Java virtual machine, or a machine instruction compiled by a bytecode; and when the software security vulnerability is a Native layer vulnerability, the repair code includes a machine instruction compiled by a program written in C/C++ language for repairing the security vulnerability.

In some embodiments, the main control module compiles the computer application software and the computer system software into a language code text, and acquires, according to the language code text, a data structure of the computer application software and the computer system software; and the software vulnerability scanning module and the system virus scanning module scan the data structure.

In some embodiments, the software vulnerability repairing module repairs the security vulnerability of the computer application software, and the software vulnerability repairing module includes a repair program central download module, a repair program central cache module and a proxy module; the proxy module sends a download command to the repair program central download module, and the repair program central download module is configured to determine whether there is a repair program for the vulnerability in the repair program central cache module; when there is a repair program for the vulnerability, the repair program is read out and sent to the proxy module; and when there is no repair program, a repair program is acquired from the software vulnerability definition central database and sent to the proxy module, to find out and repair the security vulnerability of the computer application software.

In some embodiments, the system virus repairing module repairs a computer system software exception caused by a virus, and performs a system repair for the computer system software; when there is a system repair result indicating that there is a virus at a current stage, the system virus repairing module estimates a repair time for repairing the virus; if the repair time is greater than a maximum allowable repair time at the current stage, the system virus repairing module performs a virus killing operation on some of the viruses; and if the repair time is not greater than the maximum allowable repair time, the system virus repairing module performs a virus killing operation on all the viruses, where the virus killing operation includes forced deletion and thorough crushing of files.

Further, a method for repairing a security vulnerability of computer application software using the device for repairing the security vulnerability of the computer application software, including two implementation modes: I. the main control module of the vulnerability repairing software automatically scans the computer application software for a security vulnerability and the computer system software for a system virus regularly, and sends, according to a scanning result, a command to the software vulnerability repairing module and the system virus repairing module to repair the security vulnerability of the computer application software and the system virus of the computer system software; II. a user automatically controls the vulnerability repairing software to scan the computer application software for a security vulnerability and the computer system software for a system virus, and sends, according to a scanning result, a command to the software vulnerability repairing module and the system virus repairing module to repair the security vulnerability of the computer application software and the system virus of the computer system software.

In some embodiments, the mode I includes following steps: a. the main control module of the vulnerability repairing software automatically sends a scanning notification to the software vulnerability scanning module and the system virus scanning module, the software vulnerability scanning module scans the computer application software for a security vulnerability, and the system virus scanning module scans the computer system software for a system virus, and then the software vulnerability scanning module and the system virus scanning module send a scanning result back to the main control module, respectively; b. the main control module sends the scanning result to the software vulnerability definition central database and the system virus definition central database respectively for comparison and processes the scanning result; c. when there is a security vulnerability, the main control module sends a vulnerability repair command to the software vulnerability repairing module to repair security vulnerability of the computer application software; and when there is a system virus, the main control module sends a virus killing command to the system virus repairing module to deal with the system virus of the computer system software.

In some embodiments, the mode II includes following steps: a. the user controls the main control module of the vulnerability repairing software to send a scanning notification to the software vulnerability scanning module and the system virus scanning module; the software vulnerability scanning module and the system virus scanning module respectively scan the computer application software for a security vulnerability and the computer system software for a system virus, and send a scanning result back to the main control module; b. the main control module sends the scanning result to the software vulnerability definition central database and the system virus definition central database respectively for comparison and processes the scanning result; c. when there is a security vulnerability, the main control module sends a vulnerability repair command to the software vulnerability repairing module to repair the security vulnerability of the computer application software; and when there is a system virus, the main control module sends a virus killing command to the system virus repairing module to deal with the system virus of the computer system software.

In the description of the present disclosure, unless otherwise specified and limited, the terms “installation”, “link”, “connection” and “fixation” shall be understood in a broad sense, for example, they may be fixed connection, detachable connection or integrated; they may be mechanical connection or electrical connection; they may be directly connected, or indirectly connected through an intermediate medium; or they may be a connection within two elements or an interaction between two elements. For a person of ordinary skill in the art, the specific meanings of the above terms in the present disclosure can be understood in specific cases.

All the standard parts used in the present disclosure can be purchased from the market, and all the special-shaped parts can be customized according to the description and drawings. The specific connection mode of each part adopts the conventional means such as bolts, rivets, welding, etc., which are mature in the prior art, and the machinery, parts and equipment adopt the conventional models in the prior art; in addition, the circuit connection adopts the conventional connection mode in the prior art, which will not be described in detail here.

Although embodiments of the present disclosure have been shown and described, it will be understood by a person of ordinary skill in the art that various changes, modifications, substitutions and variants can be made to these embodiments without departing from the principles and spirit of the present disclosure, and the scope of the present disclosure is defined by the appended claims and their equivalents.

1. A device for repairing a security vulnerability of computer application software, comprising: vulnerability repairing software, computer application software and computer system software, wherein the vulnerability repairing software comprises a main control module, a software vulnerability repairing module, a software vulnerability scanning module, a system virus repairing module, a system virus scanning module, a software vulnerability definition central database and a system virus definition central database; and wherein the main control module, the software vulnerability repairing module, the software vulnerability scanning module, the system virus repairing module, the system virus scanning module, the software vulnerability definition central database and the system virus definition central database interact information with the computer application software and the computer system software; the main control module sends a notification to the software vulnerability scanning module and the system virus scanning module, respectively; the software vulnerability scanning module scans the computer application software for a security vulnerability and sends a scanning result to the software vulnerability definition central database for comparison, and the software vulnerability repairing module sends, according to the comparison, a repair command to repair the computer application software; and the system virus scanning module scans the computer system software for a system virus and sends a scanning result to the system virus definition central database for comparison, and the system virus repairing module sends a virus-killing command according to the comparison.

2. The device for repairing the security vulnerability of the computer application software of claim 1, wherein the software vulnerability repairing module comprises a repair code, and when the software security vulnerability is a Java layer vulnerability, the repair code comprises a bytecode compiled by a program written in Java language for repairing the security vulnerability and running in a Java virtual machine, or a machine instruction compiled by a bytecode; and when the software security vulnerability is a Native layer vulnerability, the repair code comprises a machine instruction compiled by a program written in C/C++ language for repairing the security vulnerability.

3. The device for repairing the security vulnerability of the computer application software of claim 1, wherein the main control module compiles the computer application software and the computer system software into a language code text, and acquires, according to the language code text, a data structure of the computer application software and the computer system software; and the software vulnerability scanning module and the system virus scanning module scan the data structure.

4. The device for repairing the security vulnerability of the computer application software of claim 1, wherein the software vulnerability repairing module repairs the computer application software security vulnerability, and the software vulnerability repairing module comprises a repair program central download module, a repair program central cache module and a proxy module; the proxy module sends a download command to the repair program central download module, and the repair program central download module is configured to determine whether there is a repair program for the vulnerability in the repair program central cache module; when there is a repair program for the vulnerability, the repair program is read out and sent to the proxy module; when there is no repair program, a repair program is acquired from the software vulnerability definition central database and sent to the proxy module, to find out and repair the security vulnerability of the computer application software.

5. The device for repairing the security vulnerability of the computer application software of claim 1, wherein the system virus repairing module repairs a computer system software exception caused by a virus, and performs a system repair for the computer system software; when there is a system repair result indicating that there is a virus at a current stage, the system virus repairing module estimates a repair time for repairing the virus; if the repair time is greater than a maximum allowable repair time at the current stage, the system virus repairing module performs a virus killing operation on some of the viruses; and if the repair time is not greater than the maximum allowable repair time, the system virus repairing module performs a virus killing operation on all the viruses, wherein the virus killing operation comprises forced deletion and thorough crushing of files.

6. A method for repairing a security vulnerability of computer application software using the device for repairing the security vulnerability of the computer application software of claim 1, comprising two implementation modes: I. the main control module of the vulnerability repairing software automatically scans the computer application software for a security vulnerability and the computer system software for a system virus regularly, and sends, according to a scanning result, a command to the software vulnerability repairing module and the system virus repairing module to repair the security vulnerability of the computer application software and the system virus of the computer system software; II. a user automatically controls the vulnerability repairing software to scan the computer application software for a security vulnerability and the computer system software for a system virus, and sends, according to a scanning result, a command to the software vulnerability repairing module and the system virus repairing module to repair the security vulnerability of the computer application software and the system virus of the computer system software.

7. The method for repairing the security vulnerability of the computer application software of claim 6, wherein the mode I comprises following steps: a. the main control module of the vulnerability repairing software automatically sends a scanning notification to the software vulnerability scanning module and the system virus scanning module, the software vulnerability scanning module scans the computer application software for a security vulnerability, and the system virus scanning module scans the computer system software for a system virus, and then the software vulnerability scanning module and the system virus scanning module send a scanning result back to the main control module, respectively; b. the main control module sends the scanning result to the software vulnerability definition central database and the system virus definition central database respectively for comparison and processes the scanning result; c. when there is a security vulnerability, the main control module sends a vulnerability repair command to the software vulnerability repairing module to repair the security vulnerability of the computer application software; and when there is a system virus, the main control module sends a virus killing command to the system virus repairing module to deal with the system virus of the computer system software.

8. The method for repairing the security vulnerability of the computer application software of claim 6, wherein the mode II comprises following steps: a. the user controls the main control module of the vulnerability repairing software to send a scanning notification to the software vulnerability scanning module and the system virus scanning module; the software vulnerability scanning module and the system virus scanning module respectively scan the computer application software for a security vulnerability and the computer system software for a system virus, and send a scanning result back to the main control module; b. the main control module sends the scanning result to the software vulnerability definition central database and the system virus definition central database respectively for comparison and processes the scanning result; c. when there is a security vulnerability, the main control module sends a vulnerability repair command to the software vulnerability repairing module to repair the security vulnerability of the computer application software; and when there is a system virus, the main control module sends a virus killing command to the system virus repairing module to deal with the system virus of the computer system software.
